(19) United States
(12) Patent Application Publication
(10) Pub. No.: US 2010/0182534 A1
(43) Pub. Date: Jul. 22, 2010

(54) LIQUID CRYSTAL DISPLAY DEVICE

(76) Inventors: Naru Usukura, Osaka-shi (JP); Satoshi Shibata, Osaka-shi (JP)

Correspondence Address: NIXON & VANDERHYE, PC, 901 NORTH GLEBE ROAD, 11TH FLOOR, ARLINGTON, VA, 22203, US

(21) Appl. No.: 12/664,983

(22) PCT Filed: May 29, 2008
(86) PCT No.: PCT/JP2008/001350

§ 371 Date: Dec. 16, 2009

(30) Foreign Application Priority Data
Jun. 18, 2007 (JP) 2007-160266

(51) Int. Cl. G02F 1/13357

(52) U.S. Cl. 349/62

(57) ABSTRACT

There is provided a liquid crystal display device in which display defects that would be caused by asymmetry of light emitted from a backlight are reduced and which is capable of providing brightness with improved symmetry about the direction vertical to the display surface.

The liquid crystal display device includes a backlight configured to emit light toward a liquid crystal panel and a microlens array interposed between the liquid crystal panel and the backlight. The backlight emits the light toward the microlens array such that the average propagation direction of the emitted light is a second direction, the second direction being different from a first direction that is perpendicular to a light receiving surface of the liquid crystal panel. Each of the plurality of microlenses has an asymmetric shape about an axis which is perpendicular to the light receiving surface and which passes through the center of the microlens, and emits light toward the liquid crystal panel such that the average propagation direction of the emitted light is nearer to the first direction than the second direction.

### TECHNICAL FIELD

The present invention relates to a liquid crystal display device and specifically to a liquid crystal display device which includes a microlens array.

### BACKGROUND ART

In recent years, liquid crystal display devices are widely used as display devices for monitors, projectors, mobile information terminals, mobile phones, and the like. Generally speaking, a liquid crystal display device allows the transmittance (or reflectance) of a liquid crystal panel to vary with a driving signal, thus modulating the intensity of light from a light source for irradiating the liquid crystal panel, whereby images and text characters are displayed. Liquid crystal display devices include direct-viewing type display devices in which images or the like that are displayed on the liquid crystal panel are directly viewed, projection-type display devices (projectors) in which images that are displayed on the liquid crystal panel are projected onto a screen through a projection lens in an enlarged size, and so on.

By applying a driving voltage which corresponds to an image signal to each of the pixels that are in a regular matrix arrangement, a liquid crystal display device causes a change in the optical characteristics of a liquid crystal layer in each pixel, and regulates the transmitted light in accordance with the optical characteristics of the liquid crystal layer with polarizers (which typically are polarizing plates) being disposed at the front and rear thereof, thereby displaying images, text characters, and the like. In the case of a direct-viewing type liquid crystal display device, usually, these polarizing plates are directly attached to a light-entering substrate (the rear substrate) and a light-outgoing substrate (the front substrate or viewer-side substrate) of the liquid crystal panel.

Methods for applying an independent driving voltage for each pixel include a passive matrix type and an active matrix type. Among these, on a liquid crystal panel of the active matrix type, switching elements and wiring lines for supplying driving voltages to the pixel electrodes need to be provided. As switching elements, non-linear 2-terminal devices such as MIM (metal-insulator-metal) devices and 3-terminal devices such as TFT (thin film transistor) devices are in use.

On the other hand, in a liquid crystal display device of the active matrix type, when strong light enters a switching element (in particular a TFT) which is provided on the display panel, its element resistance in an OFF state is decreased, thereby allowing the electric charge which was charged to the pixel capacitor under an applied voltage to be discharged, such that a predetermined displaying state cannot be obtained. Thus, there is a problem of light leakage even in a black state, thus resulting in a decreased contrast ratio.

Therefore, in a liquid crystal display panel of the active matrix type, in order to prevent light from entering the TFTs (in particular channel regions), a light shielding layer (black matrix) is provided on a TFT substrate on which the TFTs and the pixel electrodes are provided, or on a counter substrate that opposes the TFT substrate via the liquid crystal layer, for example.

Now, in the case where the liquid crystal display device is a reflection-type liquid crystal display device, decrease in the effective pixel area can be prevented by utilizing reflection electrodes as a light shielding layer. However, in a liquid crystal display device which performs displaying by utilizing transmitted light, providing a light shielding layer in addition to the TFTs, gate bus lines, and source bus lines, which do not transmit light, will allow the effective pixel area to be decreased, thus resulting in a decrease in the ratio of the effective pixel area to the total area of the displaying region, i.e., the aperture ratio.

Liquid crystal display devices are characterized by their light weight, thinness, and low power consumption, and therefore are widely used as display devices of mobile devices such as mobile phones and mobile information terminals. With a view to increasing the amount of displayed information, improving the image quality, and so on, there are stronger and stronger desires for display devices to have higher resolutions. Conventionally, it has been a standard to adopt QVGA displaying by 240×320 pixels for liquid crystal display devices of the 2 to 3-inch class, for example, but devices which perform VGA displaying by 480×640 pixels have also been produced in the recent years.

As liquid crystal panels become higher in resolution and smaller in size, the aforementioned decrease in their aperture ratio presents a greater problem. The reason is that, even if there is a desire to reduce the pixel pitch, constraints such as electrical performance and fabrication techniques make it impossible for the TFTs, the bus lines, etc., to become smaller than certain sizes. It might be possible to enhance the brightness of light supplied from the backlight in order to compensate for the decreased transmittance, but this will induce an increased power consumption, thus presenting a particular problem to mobile devices.

In recent years, as display devices of mobile devices, transflective-type liquid crystal display devices have become prevalent, which perform displaying under dark lighting by utilizing light from a backlight, and which perform displaying under bright lighting by reflecting light entering the display surface of the liquid crystal panel. In a transflective-type liquid crystal display device, a region (reflection region) which performs displaying in the reflection mode and a region (transmission region) which performs displaying in the transmission mode are included in each pixel. Therefore, reducing the pixel pitch significantly will lower the ratio of the area of the transmission region to the total area of the displaying region (aperture ratio of the transmission region). Thus, although transflective-type liquid crystal display devices have the advantage of realizing displaying with a high contrast ratio irrespective of the ambient brightness, they have a problem in that their brightness is lowered as the aperture ratio of the transmission region becomes smaller.

As a method for improving the efficiency of light utility of such a liquid crystal display device including transmission regions, Patent Document 1 discloses providing microlenses for converging light in each pixel on the liquid crystal panel in order to improve the effective aperture ratio of the liquid crystal panel. Patent Document 2 discloses using microlenses for converging incident light and allowing the light to be emitted with a slant in a direction corresponding to the azimuth of the pretilt of the liquid crystal.

[Patent Document 1] . . . Japanese Laid-Open Patent Publication No. H5-333328

[Patent Document 2] . . . Japanese Laid-Open Patent Publication No. 2006-184673

### DISCLOSURE OF INVENTION

### Problems to be Solved by the Invention

Backlights for liquid crystal display devices include direct lighting type backlights in which a light source is placed just under a display panel, and edge light type (light guide plate type) backlights in which a light source is disposed on a side face of a light guide plate placed just under the display panel. The edge light type backlights have a relatively thin body and are therefore suitable to direct-viewing type liquid crystal display devices, of which reduction of the device size is demanded, and especially suitable to liquid crystal display devices for mobile applications, laptop computers, etc.

When a microlens array is applied to a direct-viewing type liquid crystal display device, the backlight used desirably emits light which is as near to parallel light as possible and which has high directivity, i.e., light which has high directivity in a direction vertical to the display surface. An example of such a backlight is an edge light type backlight which uses a turning lens (TL) or a reversed prism (RP).

FIG. 6 is a cross-sectional view schematically showing an example of such a backlight. As shown in the drawing, a backlight 10 includes a light guide plate 12, an LED 14 which is a light source placed on one side surface of the light guide plate 12, a reflector 16 placed under the light guide plate 12, and a prism sheet 18 placed over the light guide plate 12 (on the liquid crystal panel side).

The lower part of the light guide plate 12, which faces to the reflector 16, has saw-tooth grooves (gaps) 20. As a result, the bottom surface 22 of the light guide plate 12 has a plurality of slope surfaces 24 which have different slope angles θ. Here, the plurality of slope surfaces 24 are shaped such that the slope angle θ increases as it is more distant from the LED 14. The prism sheet 18 has a plurality of prism portions 26 which are downwardly tapered. The light source may be a cold-cathode tube in place of the LED 14. The LED 14 may be placed in a corner formed by two side surfaces of the light guide plate 12.

Light emitted from the LED 14 is reflected by the reflector 16 or the slope surfaces 24 of the light guide plate 12 and then passes through an upper surface (emission surface) 25 of the light guide plate 12. The light which has passed through the upper surface 25 is then refracted by the prism portions 26 of the prism sheet 18 and emitted from an emission surface 28 toward a liquid crystal panel placed over the backlight.

The gaps between the light guide plate 12 and the prism sheet 18 and the grooves 20 are filled with air. Part of the light emitted from the LED 14 which is incident on the bottom surface 22 and the upper surface 25 of the light guide plate 12 with an angle equal to or greater than the critical angle is totally reflected by these surfaces. On the other hand, another part of the light which is incident on the bottom surface 22 and the upper surface 25 with an angle smaller than the critical angle is partially reflected while the remaining part is refracted and output from the bottom surface 22 or the upper surface 25. The light output from the bottom surface 22 is reflected by the reflector 16 to again enter the light guide plate 12, while the light output from the upper surface 25 advances toward the prism sheet 18.

With such a setup, light propagating in the light guide plate 12 is gradually emitted toward the prism sheet 18 while repeatedly undergoing reflection and refraction. During this process, light emitted from the light guide plate 12 has directivity in a direction inclined from a direction vertical to the upper surface 25. Assuming that the direction vertical to the upper surface 25 is the viewing angle of 0° and the direction leaving from the LED 14 along the upper surface 25 (direction from left to right of the drawing) is the viewing angle of 90°, this direction of directivity is, as shown in the drawing, in the range of viewing angles equal to or greater than 45° and smaller than 90°.

Here, light “having directivity” means that emitted light has a greater intensity in a specific direction. The degree of directivity, i.e., how high the directivity in the specific direction is, is represented by the half-width angles in the intensity distribution of the emitted light as will be explained later with reference to FIG. 8. Also, the direction indicated by the midpoint value of the half-width angles is herein defined as “direction of directivity”.

Next, the functions of the prism sheet 18 to the light emitted from the upper surface 25 of the light guide plate 12 are described with reference to FIG. 7.

FIG. 7 shows the behavior of light reflected or refracted by a surface 30 of the prism portions 26 of the prism sheet 18.

As shown in the drawing, light La incident on the surface 30 of the prism portions 26 with angle θa which is equal to or greater than critical angle θC is totally reflected by the surface 30, and all the part of the total reflection (light La′) advances toward the liquid crystal panel. On the other hand, light Lb, the incident angle of which is smaller than critical angle θC, is separated by the surface 30 into reflected light Lb′ and refracted light Lb″.

The surface 30 of the prism sheet 18 reflects and refracts the light in this way, and the light incident on the prism sheet 18 has directivity in the above-described direction. Therefore, large part of the light advancing from the prism sheet 18 toward the liquid crystal panel propagates in viewing angle directions greater than 0°. In other words, the average propagation direction of the light advancing from the prism sheet 18 toward the liquid crystal panel is a viewing angle direction greater than 0°. The direction of its directivity is also a viewing angle direction greater than 0°.

Since the prism portions 30 have a downwardly tapered shape, the light which has passed through the prism sheet 18 scarcely include light advancing in an azimuthal direction greater than the slope angle θs of the surface 30. Therefore, the brightness of the light emitted from the backlight 10 significantly decreases in the viewing angle range of θs to 90° and the viewing angle range of −θs to −90°.

FIG. 8 shows the viewing angle dependency of the brightness of the emitted light advancing from the backlight 10 toward the liquid crystal panel. As shown in the drawing, the half value angles of the brightness are θ1 and −θ2, and θ1 is greater than θ2. Therefore, the midpoint of the half value angle width, θm, is greater than 0°. This means that the brightness distribution of the emitted light is asymmetric about the viewing angle 0° and that the direction of directivity of the emitted light is on the positive viewing angle side. This also means that the average propagation direction of the emitted light is not the direction of viewing angle 0° but a greater angle direction.

When a liquid crystal display device which includes microlenses is used to perform high quality display, it is required that the light emitted from the backlight to the microlenses is as near to parallel light as possible such that it is vertically incident on the display surface and that the light need to be uniform without unevenness in brightness distribution. However, when the emitted light from the backlight 10 is asymmetric as described above, the brightness asymmetry also appears in the display of the liquid crystal display device, resulting in display with nonuniform viewing angle characteristics and noticeable brightness unevenness.

None of the aforementioned patent documents suggests researches on or solutions to such problems. Patent Document 2 describes using microlenses for deflecting the light before being emitted therefrom. However, Patent Document 2 also states that the entirety of light incident on the microlenses is vertically incident on the display surface and fails to present the above-described problems or suggest solutions to the problems.

The inventor of the present application found that a liquid crystal display device which includes the backlight 10 entails the above-described brightness asymmetry problem and that extremely high quality display in such a liquid crystal display device cannot be achieved without solving the asymmetry problem.

The present invention was conceived in view of the above problems. One of the objectives of the present invention is to provide a liquid crystal display device in which display defects that would be caused by the asymmetry of light emitted from the backlight are reduced and which is capable of high brightness display with decreased display unevenness.

### Means for Solving the Problems

A liquid crystal display device of the present invention includes: a liquid crystal panel which includes a pair of substrates and a liquid crystal layer interposed between the pair of substrates; a backlight configured to emit light emitted from a light source toward the liquid crystal panel; and a microlens array interposed between the liquid crystal panel and the backlight, the microlens array including a plurality of microlenses, wherein the backlight emits light toward the microlens array such that an average propagation direction of emitted light is a second direction, the second direction being different from a first direction that is perpendicular to a light receiving surface of the liquid crystal panel, and each of the plurality of microlenses has an asymmetric shape about an axis which is perpendicular to the light receiving surface and which passes through a center of the microlens, and emits light toward the liquid crystal panel such that an average propagation direction of emitted light is nearer to the first direction than the second direction.

In one embodiment, the backlight includes a light guide plate for guiding light emitted from the light source, a reflector, and a plurality of prisms interposed between the light guide plate and the microlens array. The second direction is a direction inclined from the first direction toward a third direction, the third direction being a propagation direction of light advancing from the light source to the light guide plate.

In one embodiment, a direction of directivity of light emitted from the backlight is inclined to the third direction rather than the first direction, and a direction of directivity of light emitted from the microlens array is nearer to the first direction than a direction of directivity of light emitted from the backlight is.

In one embodiment, a light receiving surface of each of the plurality of microlenses includes a first curve surface which has a first curvature and a second curve surface which is more distant from the light source than the first curve surface is and which has a second curvature, the second curvature being different from the first curvature.

In one embodiment, the area of the second curve surface is larger than the area of the first curve surface when seen in a direction perpendicular to a surface of the pair of substrates.

In one embodiment, the light receiving surface of each of the plurality of microlenses includes a flat surface between the first curve surface and the second curve surface.

In one embodiment, an area ratio of the first curve surface to the flat surface is not less than 0.2 and not more than 0.6, and an area ratio of the second curve surface to the flat surface is not less than 0.3 and not more than 0.8, when seen in a direction perpendicular to a surface of the pair of substrates.

In one embodiment, a radius of curvature of the first curve surface is not less than 30 μm and not more than 40 μm, and a radius of curvature of the second curve surface is not less than 50 μm and not more than 60 μm.

### Effects of the Invention

According to the present invention, a microlens which has an asymmetric shape is used to converge light emitted from a backlight on a pixel while correcting inclination in the direction of directivity of the light supplied from the backlight (a deviation from the direction vertical to the light receiving surface) or viewing angle-related asymmetry of the emitted light (or inclination in the average propagation direction). Therefore, high-quality display with small display unevenness and high brightness across the entire display surface can be provided without using a special element for correction of the light emitted from the backlight.

### BRIEF DESCRIPTION OF DRAWINGS

FIG. 1 A cross-sectional view schematically showing a structure of a liquid crystal display device of an embodiment.

FIG. 2 A diagram showing a cross-sectional shape of a microlens of the embodiment.

FIG. 3 A graph showing the viewing angle dependency of the brightness of emitted light of a backlight of the embodiment.

FIG. 4 Illustration of the paths of light passing through a microlens of a reference example. (a) shows a cross-sectional shape of the microlens and the paths of light passing therethrough. (b) to (d) illustrate the viewing angle characteristics of the light after being passed through the microlens.

FIG. 5 Illustration of the paths of light passing through the microlens of the embodiment. (a) shows a cross-sectional shape of the microlens and the paths of light passing therethrough. (b) to (d) illustrate the viewing angle characteristics of the light after being passed through the microlens. (e) illustrates the viewing angle characteristics of the entirety of the light which has passed through the microlens.

FIG. 6 A cross-sectional view schematically showing an example of the backlight.

FIG. 7 A diagram showing the behavior of light reflected or refracted by the prism portions 26 of the prism sheet of the backlight.

FIG. 8 Illustration of the viewing angle dependency of the brightness of the emitted light advancing from the backlight to the liquid crystal panel.

### DESCRIPTION OF THE REFERENCE NUMERALS

10 backlight

12 light guide plate

14 LED

16 reflector

18 prism sheet

20 groove (gap)

22 bottom surface

24 slope surface

25 upper surface (emission surface)

26 prism portion

28 emission surface

50 liquid crystal display panel

51 liquid crystal panel

52 microlens array

52a microlens

53 support

54 front-face side optical film

55 rear-face side optical film

56 protection layer

57, 58 adhesion layer

60 electric element substrate

62 counter substrate

64 liquid crystal layer

66 sealant

70 light receiving surface (bottom surface)

71 axis

75, 75′, 76, 76′ curve surface

77, 77′ flat surface

100 liquid crystal display device

### BEST MODE FOR CARRYING OUT THE INVENTION

Hereinafter, an embodiment of the liquid crystal display device of the present invention is described with reference to the drawings.

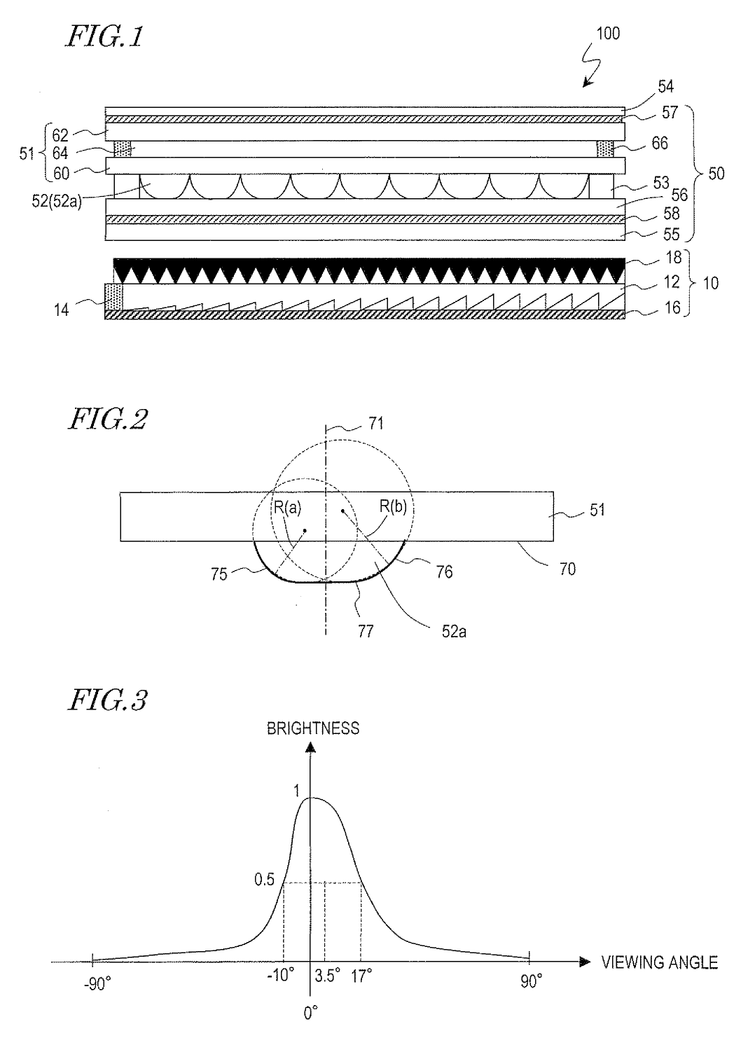

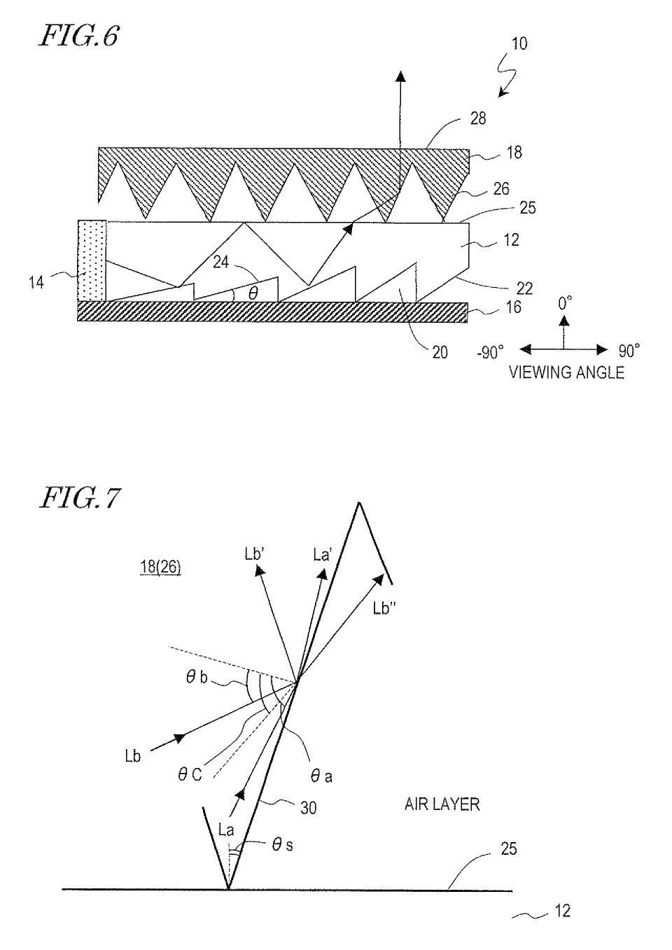

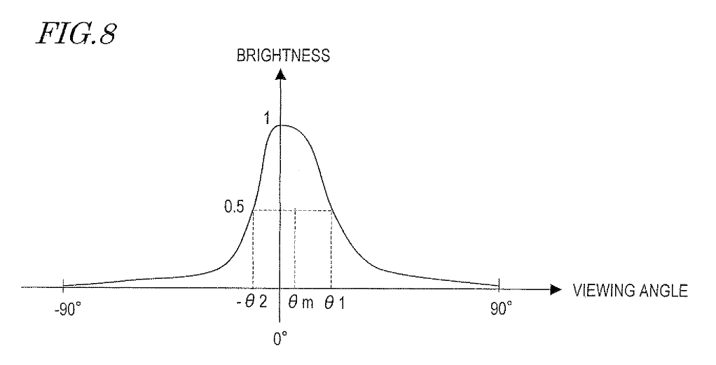

FIG. 1 is a cross-sectional view schematically showing a structure of a liquid crystal display device 100 of the present embodiment. As shown in the drawing, the liquid crystal display device 100 includes a liquid crystal display panel (a liquid crystal panel with microlenses) 50 and a backlight 10 placed under the liquid crystal display panel 50 (on the surface opposite to the display surface). The backlight 10 has the same structure as that previously described with reference to FIG. 6, and therefore, the description of its structure is herein omitted. The backlight 10 is configured such that the direction of directivity of the light emitted therefrom is inclined to the positive viewing angle side as previously described with reference to FIG. 8.

The liquid crystal display panel 50 includes a liquid crystal panel (laminate substrate) 51 including a plurality of pixels in a matrix arrangement, a microlens array 52 including a plurality of microlenses 52a provided over a light receiving surface of the liquid crystal panel 51 (the bottom surface of the liquid crystal panel 51 which extends perpendicularly to the sheet of the drawing), a support 53 provided in a perimeter region of the microlens array 52, a front-face side optical film 54 provided on the viewer side of the liquid crystal panel 51 (upper side of the drawing), a rear-face side optical film 55 which is provided on the light-incident side of the microlens array 52, and a protection layer 56 interposed between the rear-face side optical film 55 and the microlens array 52.

The protection layer 56 is made of a photocurable resin and provided so as to be in contact with the microlens array 52 and the support 53. The protection layer 56 and the microlens array 52 are bonded together such that the protection layer 56 is in contact with the microlens array 52 only at positions near the apexes of the respective microlenses 52a and that gaps containing air are formed between the microlens array 52 and the protection layer 56.

The front-face side optical film 54 is bonded to the liquid crystal panel 51 via an adhesion layer 57. The rear-face side optical film 55 is bonded to the protection layer 56 via an adhesion layer 58. The front-face side optical film 54 and the rear-face side optical film 55 each include a polarization film which transmits linearly-polarized light.

The protection layer 56 is made of a UV-curable acrylic or epoxy resin which has high visible-light transmittance, but may alternatively be made of a thermosetting resin. The protection layer 56 and the support 53 are preferably made of the same material as the microlenses 52a or a material which has substantially the same refractive index as that of the material of the microlenses 52a.

The liquid crystal panel 51 includes an electric element substrate 60 which has switching elements (for example, TFTs, MIM elements) in respective pixels, a counter substrate 62 which is, for example, a color filter substrate (CF substrate), and a liquid crystal layer 64. The liquid crystal layer 64 includes a liquid crystal material encapsulated between the electric element substrate 60 and the counter substrate 62 and is tightly sealed by a sealant 66 provided at the perimeter.

The microlenses 52a of the microlens array 52 are lenticular lenses elongated correspondingly to the columns of the pixels in a matrix arrangement over the liquid crystal panel 51 (in a direction perpendicular to the sheet of the drawing). The pixel pitch (the width of one pixel) is about 170 μm. The width of the microlenses 52a corresponds to the pixel pitch.

FIG. 1 shows the cross-sectional structure of the microlenses 52a taken along a plane perpendicular to the longitudinal direction of the microlenses 52a. The details of the cross-sectional structure are described with reference to FIG. 2. Note that the microlenses 52a may be microlenses each of which corresponds to one pixel.

FIG. 2 shows a cross-sectional shape of the microlens 52a. As shown in the drawing, the microlens 52a has an asymmetric shape about an axis 71 which is perpendicular to a light receiving surface (bottom surface) 70 of the liquid crystal panel 51 and which passes through the center of the microlens 52a. The microlens 52a has an asymmetric shape about a plane which is perpendicular to the light receiving surface of the liquid crystal panel 51 and which passes through the center of the microlens 52a.

The light receiving surface (lower surface) of the microlens 52a includes a curve surface (first curve surface) 75 with the radius of curvature R(a), a curve surface (second curve surface) 76 with the radius of curvature R(b) which is different from R(a), and a flat surface 77 between the curve surface 75 and the curve surface 76. The curve surface 75 is a side surface of the microlens 52a which is closer to a light source 14 of the backlight 10 than the curve surface 76 is.

The curve surface 76 has a greater radius of curvature (smaller curvature) than the curve surface 75. In the case where the pixel pitch is 170 μm, the radius of curvature R(a) of the curve surface 75 is, for example, 35 μm, the radius of curvature R(b) of the curve surface 76 is, for example, 55 μm, and the height of the microlens 52a is, for example, 25.0 μm. Note that the radius of curvature R(a) of the curve surface 75 is preferably not less than 30 μm and not more than 40 μm. The radius of curvature R(b) of the curve surface 76 is preferably not less than 50 μm and not more than 60 μm. The height of the microlens 52a is preferably not less than 10 μm and not more than 35 μm. The optimum shape of the microlens 52a is not limited to the above specifications. The microlens 52a may be formed into a different shape according to the pixel pitch, the aperture shape of the pixels, the required characteristics, etc.

The microlens 52a is shaped such that the area of the curve surface 76 is larger than that of the curve surface 75 when seen in a direction perpendicular to the light receiving surface 70 of the liquid crystal panel 51 or in a direction perpendicular to a surface of the electric element substrate 60 or the counter substrate 62 (hereinafter referred to as “direction perpendicular to the substrate surface”).

For example, in the case where the pixel pitch is 170 μm, the radius of curvature R(a) of the curve surface 75 is 30 μm, the radius of curvature R(b) of the curve surface 76 is 50 μm, and the height (thickness) of the microlens 52a is 20 μm, the area ratios of the curve surface 75 and the curve surface 76 to the flat surface 77 when seen in a direction perpendicular to the substrate surface are 0.28 and 0.39, respectively (curve surface 75:flat surface 77:curve surface 76=0.28:1.0:0.39). In the case where the pixel pitch is 170 μm, the radius of curvature R(a) of the curve surface 75 is 40 μm, the radius of curvature R(b) of the curve surface 76 is 60 μm, and the height (thickness) of the microlens 52a is 30 μm, the area ratios of the curve surface 75 and the curve surface 76 to the flat surface 77 when seen in a direction perpendicular to the substrate surface are 0.49 and 0.66,respectively (curve surface 75:flat surface 77:curve surface 76=0.49:1.0:0.66).

The area ratio of the surface of the microlens 52a is not limited to the above values. Different area ratio values may be employed according to the shape of the microlens 52a, the pixel pitch, the required characteristics, etc. The inventors of the present application researched and found that the correction effects on the light from the backlight can be obtained when the area ratios of the curve surface 75 and the curve surface 76 to the flat surface 77 are not less than 0.2 and not more than 0.6 and not less than 0.3 and not more than 0.8, respectively (curve surface 75:flat surface 77:curve surface 76=0.2-0.6:1.0:0.3-0.8, and the area of curve surface 75<the area of curve surface 76). The inventors also found that more excellent correction effects can be obtained when the ratios of the curve surface 75 and the curve surface 76 to the flat surface 77 are not less than 0.28 and not more than 0.49 and not less than 0.39 and not more than 0.66, respectively (curve surface 75:flat surface 77:curve surface 76=0.28-0.49:1.0:0.39-0.66, and the area of curve surface 75<the area of curve surface 76).

Note that the flat surface 77 may not necessarily be parallel to the light receiving surface 70 of the liquid crystal panel 51. To obtain the effects of correcting the viewing angle asymmetry, the left edge of the flat surface 77 (the edge bordering on the curve surface 75) is higher than the right edge (more distant from the light receiving surface 70).

Neither the curve surface 75 nor the curve surface 76 may necessarily have a single curvature, but each of them may include a plurality of curve surfaces with a plurality of curvatures. In this case, the phrase “the radius of curvature R(a) of the curve surface 75 is 35 μm” means that the average of the radii of curvatures of the plurality of curve surfaces included in the curve surface 75 is 35 μm. As well, the phrase “the radius of curvature R(b) of the curve surface 76 is 55 μm” means that the average of the radii of curvatures of the plurality of curve surfaces included in the curve surface 76 is 55 μm.

The light receiving surface of the microlens 52a may not necessarily be occupied only by the curve surface 75, the curve surface 76 and the flat surface 77. The light receiving surface may include any other curve surface between the curve surface 75 or curve surface 76 and the flat surface 77 or between the curve surface 75 or curve surface 76 and the edge of the light receiving surface. A microlens which does not include the flat surface 77 falls within the extent of the microlens 52a of the present invention.

Next, the directivity of light supplied from the backlight 10 of this embodiment is described.

FIG. 3 is a diagram showing the viewing angle dependency of the brightness of emitted light of the backlight 10. The direction of directivity of this emitted light is inclined to the positive viewing angle side as previously described with reference to FIG. 8. In this embodiment, the half-value angles of the brightness are 17° and −10°, and the midpoint of the half-value angle width is 3.5°.

This shows that the average propagation direction of the emitted light is oriented in a positive viewing angle direction. Specifically, the backlight 10 emits light toward the microlens array 52 such that the average propagation direction of the light is inclined to a positive viewing angle direction relative to a direction perpendicular to the light receiving surface 70 of the liquid crystal panel (first direction), i.e., the backlight 10 emits light oriented in the second direction that is different from the first direction. In other words, the average propagation direction of the light emitted from the backlight 10 is different from a direction vertical to the light receiving surface 70 (first direction) but rather is a direction inclined to the direction of viewing angle 90° (a propagation direction of light emitted from the light source 14 to the light guide plate 12: third direction).

Next, the paths of light passing through the microlens 52a are described.

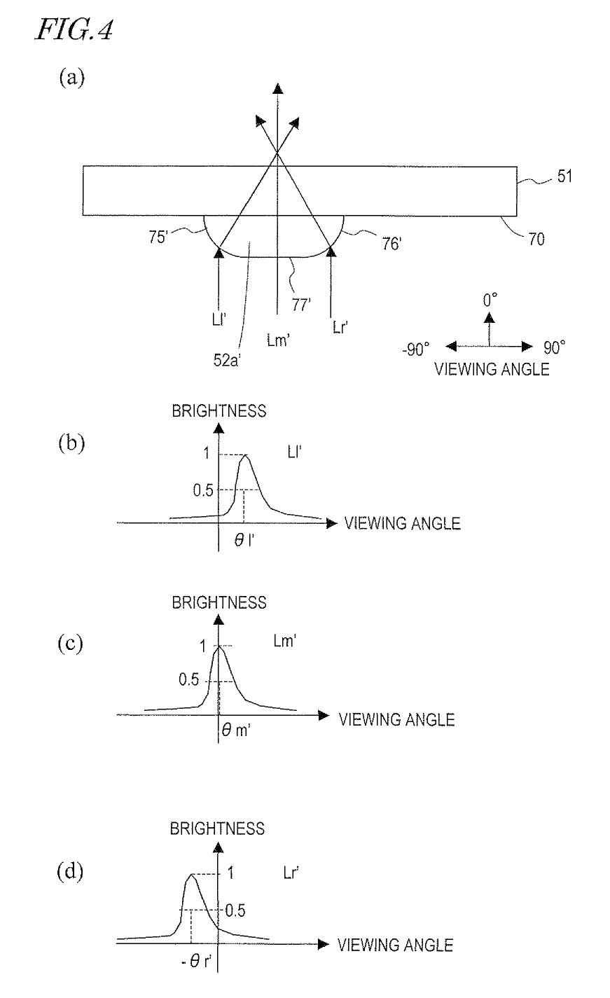

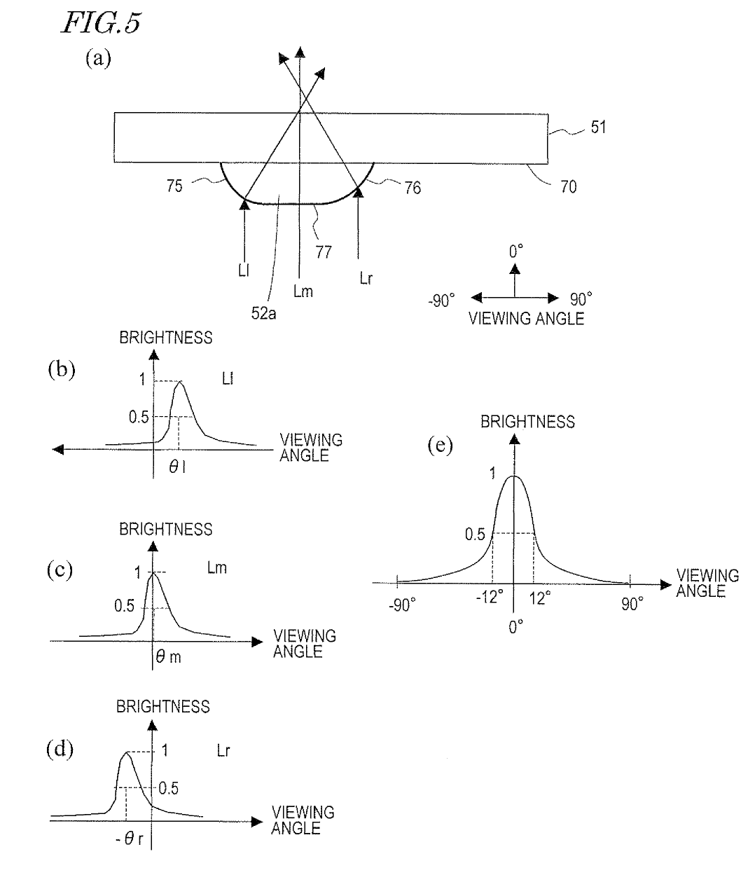

FIG. 4 illustrates the paths of light passing through a microlens 52a′ of a reference example. FIG. 4(a) shows a cross-sectional shape of the microlens 52a′ and the paths of light passing therethrough. FIGS. 4(b)-4(d) illustrate the viewing angle characteristics of the light which has passed through the microlens 52a′.

As shown in FIG. 4(a), the microlens 52a′ is different from the microlens 52a of the present embodiment in that it has a symmetric shape about an axis which is perpendicular to the light receiving surface (bottom surface) 70 of the liquid crystal panel 51 and which passes through the center of the microlens 52a′. The light receiving surface of the microlens 52a′ is formed by a curve surface 75′ and a curve surface 76′, which have the same radius of curvature, and a flat surface 77′ extending between the curve surface 75′ and the curve surface 76′. The radius of curvature of the curve surface 75′ and the curve surface 76′ is in the range of 40-50 μm. The flat surface 77′ is parallel to the light receiving surface 70 of the liquid crystal panel 51. The area of the curve surface 75′ is equal to the area of the curve surface 76′ when seen in a direction perpendicular to the substrate surface.

Light Ll′ incident on the curve surface 75′ of the microlens 52a′ is refracted by the lens to advance in a rightwardly-deflected direction (positive viewing angle direction). Light Lr′ incident on the curve surface 76′ is refracted by the lens to advance in a leftwardly-deflected direction (negative viewing angle direction). Light Lm′ incident on the fiat surface 77′ advances straight without being refracted by the lens. Note that each path of light is represented by a single arrow in the drawing whereas the actual light spreadingly propagates in the lens and also spreadingly propagates even after having passed through the lens.

FIGS. 4(b)-4(d) illustrate the viewing angle characteristics of the brightness of light Ll′, Lm′, and Lr′ after being passed through the microlens 52a′. In the drawing, the midpoints of the viewing angle half widths of light Ll′, Lm′, and Lr′ after being passed through the microlens 52a′ are represented by θl′, θm′, and −θr′, respectively.

The direction of directivity of light Ll′ is deflected by the microlens 52a′ to the positive viewing angle side (the right side of the drawing). The direction of directivity of light Lr′ is deflected by the microlens 52a′ to the negative viewing angle side (the left side of the drawing). The direction of directivity of light Lm′ does not change so that light Lm′ has substantially the same directivity as that it exhibits before passing through the lens. However, the light from the backlight 10 already has a high directivity to a positive viewing angle side, and therefore, the midpoints of the viewing angle half widths of the respective light, θl′, θm′ and −θr′, result in the relationship of θl′>0, θm′>0, −θr′<0, and θl′>θr′.

This means that light Ll′ and Lm′ have high directivity in positive viewing angle directions while light Lr′ has high directivity in a negative viewing angle direction, and that the positive direction directivity of light Ll′ is higher than the negative direction directivity of light Lr′. Thus, the entirety of the light which has passed through the microlens 52a′ (the synthesized light of Ll′, Lm′, and Lr′) still has directivity in a positive viewing angle direction.

To remove such an inclination in directivity which is still remaining in the transmitted light, the microlens 52a of this embodiment has the shape previously described with reference to FIG. 2.

FIG. 5 illustrates the paths of light passing through the microlens 52a of this embodiment. FIG. 5(a) shows a cross-sectional shape of the microlens 52a and the paths of light passing therethrough. FIGS. 5(b)-5(d) illustrate the viewing angle characteristics of the light after being passed through the microlens 52a. FIG. 5(e) illustrates the viewing angle characteristics of the entirety of the light which has passed through the microlens 52a.

As shown in FIG. 5(a), light Ll incident on the curve surface 75 of the microlens 52a is refracted by the lens to advance in a rightwardly-deflected direction (positive viewing angle direction). Light Lr incident on the curve surface 76 is refracted by the lens to advance in a leftwardly-deflected direction (negative viewing angle direction). Light Lm incident on the flat surface 77 advances straight without being refracted by the lens. The midpoints of the viewing angle half widths of light Ll, Lm, and Lr after being passed through the microlens 52a are θl, θm, and −θr, respectively, and the relationship of θl>0, θm>0, and −θr<0 holds as shown in FIGS. 5(b)-5(d).

The radius of curvature of the curve surface 75 is smaller than the radius of curvature of the curve surface 76, and therefore, light Ll transmitted through the curve surface 75 is refracted with an angle greater than the refraction angle of light Lr transmitted through the curve surface 76. Therefore, the relationship of θl>θr holds. However, with such a radius of curvature, the area of the curve surface 76 is larger than that of the curve surface 75 as described above, so that the amount of light Lr is greater than the amount of light Ll. Thus, the direction of directivity of the entirety of the light transmitted through the microlens 52a shifts to the negative side as compared with the entirety of the incident light. Comparing with the viewing angle characteristics of the reference example illustrated in FIGS. 4(b)-4(d), the area of the curve surface 75 is smaller than that of the curve surface 75′, and the area of the curve surface 76 is larger than that of the curve surface 76′. Therefore, the direction of directivity of the entirety of the light transmitted through the microlens 52a shifts to the negative side as compared with the reference example.

As described above, the amount of light Lr passing through the curve surface 76 increases relative to the entirety of the light transmitted through the microlens 52a, and the midpoint of the viewing angle half width of light Lr shifts more to a negative direction. Thus, when considering the entirety of the transmitted light, the microlens of ₜhis embodiment can deflect the direction of directivity of light more to a negative direction than the reference example can. Furthermore, the curve surface 75 and the curve surface 76 have the above-described radii of curvature, so that the waveform of the transmitted light can be finely adapted to an appropriate waveform.

FIG. 5(e) illustrates the viewing angle characteristics of the brightness of the entirety of the transmitted light. As shown in the drawing, the viewing angle half width of the entirety of the transmitted light is generally a width of −12° to 12°. The midpoint value of the width is substantially 0°. This means that the transmitted light is light of sufficiently high directivity, scarcely having an inclination in directivity.

Comparing the brightness characteristics of the emitted light from the backlight 10 which have been shown in FIG. 3 and the brightness characteristics of the transmitted light of the microlens 52a which have been shown in FIG. 5(e), it is understood that the light emitted from the backlight 10, the average propagation direction of which is inclined to the positive viewing angle side (inclined in the second direction), is converted by the asymmetrically-shaped microlens 52a to light whose average propagation direction is nearer to a direction vertical to the light receiving surface 70 (first direction) or to light whose average propagation direction is identical to the direction vertical to the light receiving surface 70. In other words, it is understood that, via transmission through the microlens 52a, light with directivity in a direction inclined to the positive viewing angle side is converted to light with directivity in another direction nearer to the direction vertical to the light receiving surface.

According to the present invention, the light emitted by the backlight is converged by the microlenses on the pixels while, at the same time, the viewing angle-related asymmetry of the emitted light or the inclination in the average propagation direction can be corrected. Therefore, a high-quality liquid crystal display device can be provided which has small display unevenness and high brightness across the entire display surface.

### INDUSTRIAL APPLICABILITY

The present invention improves the display quality of liquid crystal display devices and improves the quality of liquid crystal display panels having a relatively small aperture ratio, such as transflective-type liquid crystal display panels, and of liquid crystal display devices.

1. A liquid crystal display device, comprising:
a liquid crystal panel which includes a pair of substrates and a liquid crystal layer interposed between the pair of substrates;
a backlight configured to emit light emitted from a light source toward the liquid crystal panel; and
a microlens array interposed between the liquid crystal panel and the backlight, the microlens array including a plurality of microlenses,
wherein the backlight emits light toward the microlens array such that an average propagation direction of emitted light is a second direction, the second direction being different from a first direction that is perpendicular to a light receiving surface of the liquid crystal panel, and
each of the plurality of microlenses has an asymmetric shape about an axis which is perpendicular to the light receiving surface and which passes through a center of the microlens, and emits light toward the liquid crystal panel such that an average propagation direction of emitted light is nearer to the first direction than the second direction.

2. The liquid crystal display device of claim 1, wherein
the backlight includes a light guide plate for guiding light emitted from the light source, a reflector, and a plurality of prisms interposed between the light guide plate and the microlens array, and
the second direction is a direction inclined from the first direction toward a third direction, the third direction being a propagation direction of light advancing from the light source to the light guide plate.

3. The liquid crystal display device of claim 2, wherein
a direction of directivity of light emitted from the backlight is inclined to the third direction rather than the first direction, and a direction of directivity of light emitted from the microlens array is nearer to the first direction than a direction of directivity of light emitted from the backlight is.

4. The liquid crystal display device of claim 1, wherein
a light receiving surface of each of the plurality of microlenses includes a first curve surface which has a first curvature and a second curve surface which is more distant from the light source than the first curve surface is and which has a second curvature, the second curvature being different from the first curvature.

5. The liquid crystal display device of claim 4, wherein
the area of the second curve surface is larger than the area of the first curve surface when seen in a direction perpendicular to a surface of the pair of substrates.

6. The liquid crystal display device of claim 5, wherein
the light receiving surface of each of the plurality of microlenses includes a flat surface between the first curve surface and the second curve surface.

7. The liquid crystal display device of claim 6, wherein
an area ratio of the first curve surface to the flat surface is not less than 0.2 and not more than 0.6, and an area ratio of the second curve surface to the flat surface is not less than 0.3 and not more than 0.8, when seen in a direction perpendicular to a surface of the pair of substrates.

8. The liquid crystal display device of claim 4, wherein
a radius of curvature of the first curve surface is not less than 30 μm and not more than 40 μm, and a radius of curvature of the second curve surface is not less than 50 μm and not more than 60 μm.
